(19) United States
(12) Patent Application Publication
(10) Pub. No.: US 2008/0179926 A1
(43) Pub. Date: Jul. 31, 2008

(54) Mat Made of Flexible, Closed-Cell, Expanded Thermoplastic for Protecting a Car Seat from Pets

(76) Inventor: Jay Kushner, Miami, FL (US)

Correspondence Address: Fleit Gibbons Gutman Bongini & Bianco P.L., 21355 E. Dixie Highway, Suite #115, Miami, FL, 33180, US

(21) Appl. No.: 11/626,969

(22) Filed: Jan. 25, 2007

(51) Int. Cl. B60N 2/60; A47C 7/62

(52) U.S. Cl. 297/220; 297/219.1; 297/229

(57) ABSTRACT

A mat is made of flexible, closed-cell polyvinyl-chloride foam. The mat overlies and protects an underlying car seat. The mat can include a back portion and a leg portion. The leg portion protects the leg rest of the seat. The back portion protects the backrest of the seat.

### BACKGROUND OF THE INVENTION

1. Field of the Invention

The invention relates to mats for protecting rear seats in automobiles.

2. Description of the Related Art

One of the most expensive options in most cars is leather seats. Leather seats are valued because they add support and comfort, have improved wear, retain their value, and look better than cloth upholstery. Unfortunately, leather seats are fragile and susceptible to certain abuses. Therefore, leather seats can be easily and permanently damaged.

Dogs are a particular risk to the leather seating of cars. A dog's nails can easily puncture or scratch leather seats. Still, owners of pets need to take their dogs in their cars without damaging the leather seats of their cars.

To protect their seats from their dogs, car owners cover their seats. In the simplest cases, a car owner places a towel or blanket over the seat. However, cloth materials have a low coefficient of friction with leather. So, as the car turns, accelerates, or brakes, the blanket (usually with the dog on it) slides about the car seat. The dog can be thrown to the floor. More typically, the blanket moves and gathers and leaves the seat exposed. Then, despite the owner's efforts, the dog's nails can damage the exposed seat.

From the basic blanket, customized mats have evolved. These mats generally use mechanical devices to fix the mat to the car seat. For example, mats have been made that are buckled to the seat by a seatbelt. Others sling from the rear headrests to the front headrests. These mechanical connections do not overcome the underlying problem-the mats are made of upholstery, leather, felt, or quilting all mats with insufficient coefficients of friction with leather to prevent those mats from sliding on the leather upholstery.

Car seats can be damaged in additional ways than pets. The weight of children's car seats can permanently deform and dent leather seats. Prolonged use of car seats can lead to permanent damage from the continued rubbing of the child seat against the leather seat. Spilled food and beverages can stain the upholstery.

Cargo placed in the rear storage area can damage the upholstery and injure passengers if it shifts. Boxes and similar items stored in the cargo area (i.e. a trunk, an SUV cargo area, or a station-wagon cargo area) of a vehicle can slide on the bed. Such beds are usually carpeted. Boxes and other cargo do not have a great enough coefficient of friction with the carpet to prevent them from shifting.

In other fields, materials have been created that have non-slip qualities. However, none of these materials have ever been applied in the field of mats for protecting a car seat.

In U.S. Pat. No. 6,245,697 B1, Conrad et al. describe a flexible mat for absorbing liquids made from polymeric foam materials. Conrad et al. '697 teaches open cell foams. The open cell foams are used as an absorbent.

in U.S. Pat. No. 6,911,407 B2, Sherrod et al. describe a non-slip absorbent article. A non-adhesive skid resistant coating is applied to the exterior surface of the sheet. A number of polymers are described as non-adhesive skid-resistant coatings.

In U.S. Pat. No. 6,920,655 B2, Mitchell describes a flexible mat with a non-slip bottom.

In U.S. Pat. No. 6,673,409 B1, Wheatley describes a frictional holding pad. The pad lies on a car surface such as a dashboard. The pad has frictional non-slip properties that allow objects (i.e. cell phones) to be placed on the pad. The pad is made of expanded vinyl material. See col. 5, 11 10-34. Wheatley does not teach a pad that is shaped to work with a car seat or with suitable thickness to protect a seat.

### BRIEF SUMMARY OF THE INVENTION

It is accordingly an object of the invention to provide a mat made of flexible, closed-cell, expanded thermoplastic foam for protecting a car seat that overcomes the above-mentioned disadvantages of the heretofore-known devices and methods of this general type.

With the foregoing and other objects in view there is provided, in accordance with the invention, a mat for protecting a seat. The mat includes a leg portion. The leg portion is made of flexible, closed-cell, expanded thermoplastic foam. By being flexible, the mat is able to adapt to the shape of the underlying seat. The flexible mat can also be coiled as discussed in greater detail below. The closed-cell thermoplastic foam provides a thickness that is generally not puncturable by a dog's nails. The thickness protects the underlying seat from being damaged by a pet's nails. Thermoplastic foam has been shown to have sufficient coefficient of friction with upholstery and, most particularly, leather upholstery that a mat made of thermoplastic foam will not slide from the seat during normal driving (i.e. cornering, accelerating, and braking). The mat at least covers a leg rest of the seat that is to be configured. More preferably, the shape of the leg portion is cut to conform and complement the shape of the seat being protected. Custom cut models can be made to match given models of cars.

A back portion of the mat is connected to the leg portion. The back portion protects the backrest of the seat. The back portion can cover a portion of the backrest or be configured to cover and complement the entire face of the backrest. Like the leg portion, the back portion can be custom cut to match (i.e. complement) the backrest of the seat in a particular model of car.

The back portion can be configured to reach and cover at least a portion of a top of the seat. This allows the mat to rest on the top of the seat and prevents the mat from slouching forward. The back portion even can extend to cover a portion of a rear of the seat. By extending to the rear, the mat is prevented from slouching and exposing the car seat.

The back portion of the mat can have a hole formed therein. A headrest post of the seat can be threaded through the hole to hold the mat and prevent the mat from slouching. Typical headrests can be removed from the seat and then reinserted and threaded through the hole. For seats with headrests that cannot be removed, the mat can have a slit formed from the edge of the mat to the hole in the mat. The headrest post can be slid to the hole via the slit and, then, due to the resilient nature of the material of the mat, the slit will tend to hold the headrest within the hole to secure the mat to the seat.

The mat can include a hood. The hood is configured to cover and fit over and hold a headrest of a seat being covered. The hood is connected to the back portion of the mat. So, by placing the hood over the headrest, the mat is secured to the seat.

The mat can include a cuff. The cuff catches dirt, pet hair, and like. The cuff is connected to the leg portion. The cuff runs along the bottom edge of the mat.

A crease can be formed where the leg portion joins the back portion. The crease rests in the joint in the seat where the backrest meets the leg rest. The crease can be tucked into the seat to help secure the mat to the seat. The crease also helps the mat to be flush against the backrest and leg rest of the seat.

The flexible, closed-cell, expanded thermoplastic foam of the mat contacts the seat directly. Additional outer layers can be added. For example, padding, upholstery, and even leather can be added. As long as the thermoplastic foam layer of the mat contacts the seat, the thermoplastic foam layer will create enough friction to hold the mat on the seat.

The flexible, closed-cell, expanded thermoplastic foam is preferably at least one centimeter (>1 cm) thick. This thickness is sufficient to prevent a pet's nails from penetrating the mat and damaging the underlying seat. While thicknesses greater than three centimeters (>3 cm) are possible, the additional protection is usually overweighed by the added bulkiness of the mat when folded.

The flexible, closed-cell, expanded thermoplastic foam can be any resin with a sufficient coefficient of friction with the seat material, in particular, with leather. Examples of suitable flexible, closed-cell, expanded thermoplastic foams include polyvinyl-chloride and neoprene.

The mat provides a non-slip surface that helps to prevent the pet riding on it from being thrown to the floor. As stated, the mat is made from a resin with sufficient coefficient of friction to prevent the mat from sliding off the seat. The friction between the mat and the seat prevents the mat from gathering or folding or otherwise exposing the underlying seat during cornering, acceleration, or braking. The coefficient of friction also helps the pet to stay on the mat. By having a high enough coefficient of friction, the pet (with or without the mat) is not thrown to the floor during braking, cornering, and acceleration. The flexible resilient nature of the foam also provides a material in which the pet can use its claws (i.e. nails) to help hold itself on the mat without damaging the underlying seat.

The mat can be used to protect car seats from risks in addition to pets. For example, the mat can be used to protect a car seat from a child's car seat. The mat is placed between the seat and the car seat. The friction qualities of the mat also help to secure the child's seat on the seat. The mat can also be used to protect a seat from wear and tear of human passengers. For example, the mat according to the invention can he used to protect the seat and upholstery from food and liquid spills. The mat can also be used to protect seats and upholstery from children who may write or spill on the seat.

The mat also can be cut and configured to lie in the rear (i.e. bed) of a Sport Utility Vehicle. The mat protects the bed from wear and tear but does not slide out of position. The mat can be easily removed for quick cleaning.

Other features that are considered as characteristic for the invention are set forth in the appended claims.

Although the invention is illustrated and described herein as embodied in a mat made of flexible, closed-cell, expanded thermoplastic foam for protecting a car seat from pets, it is nevertheless not intended to be limited to the details shown, because various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1A is a right side view of an embodiment of a mat according to the invention that rests along the top of the seat.

FIG. 1B is a right side view of an embodiment of the mat according to the invention that has holes for receiving headrest posts.

FIG. 1C is a right side view of an embodiment of the mat according to the invention that has a hood for holding the mat on a headrest of the seat.

FIG. 2 is a front perspective view of the embodiment of the mat shown in FIG. 1C with the covered seat shown in phantom

FIG. 3 is a front perspective view of the embodiment of the mat shown in FIG. 1A.

FIG. 4 is perspective view of the mat in a coiled position.

FIG. 5 is a front perspective view of an embodiment of the mat according to the invention that only has a partial back portion.

FIG. 6 is a front perspective view of the embodiment shown in FIG. 1B.

FIG. 7 is a partial front perspective view of an embodiment having holes with slits for holding the posts of the headrest.

### DETAILED DESCRIPTION OF THE INVENTION

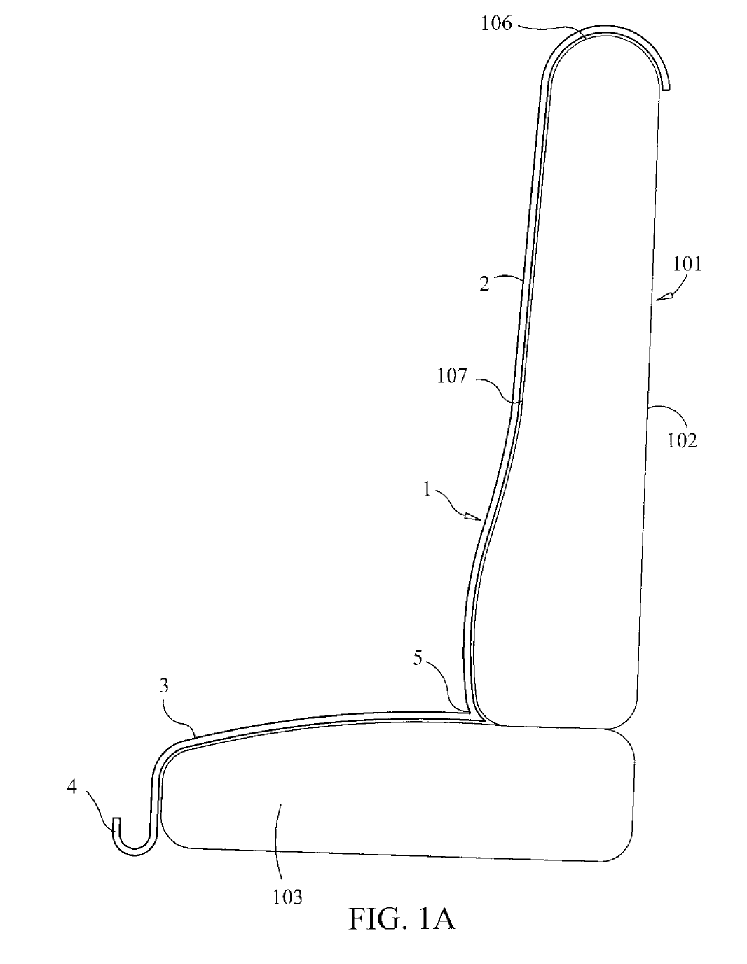

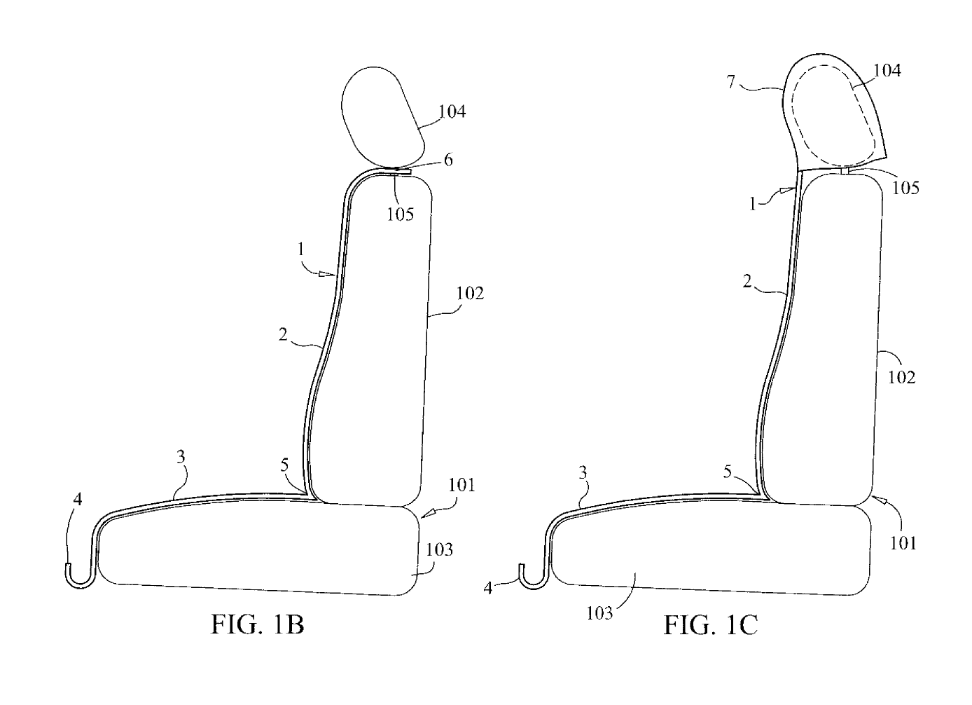

Referring now to the figures of the drawing in detail and first, particularly, to FIGS. 1A-1C thereof, there is seen a mat 1 that covers and protects a rear car seat 101. The car seat 101 includes a backrest 102 and leg rest 103. The mat 1 is made of one-half inch thick flexible, closed-cell, expanded polyvinyl-chloride (PVC) foam.

The mat 1 has a leg portion 3. The leg portion 3 overlies, covers, and protects the leg rest 103. The flexible, closed-cell PVC foam creates friction with the leg rest 103 and prevents the mat 1 from sliding or shifting on the leg rest 103. The flexible nature of the mat 1 allows the leg portion to conform to the surface of the leg rest 103.

The mat 1 includes a back portion 2. The back portion 2 overlies, covers, and protects the backrest 102. The flexible, closed-cell, expanded PVC foam creates friction with the backrest 102 and prevents the mat 1 from sliding or shifting on the backrest 102. The flexible nature of the mat 1 allows the leg portion to conform to the surface of the backrest 102.

The back portion 2 and the leg portion 3 of the mat 1 join at a crease 5. The crease 5 can be tucked between the backrest 102 and the leg rest 103.

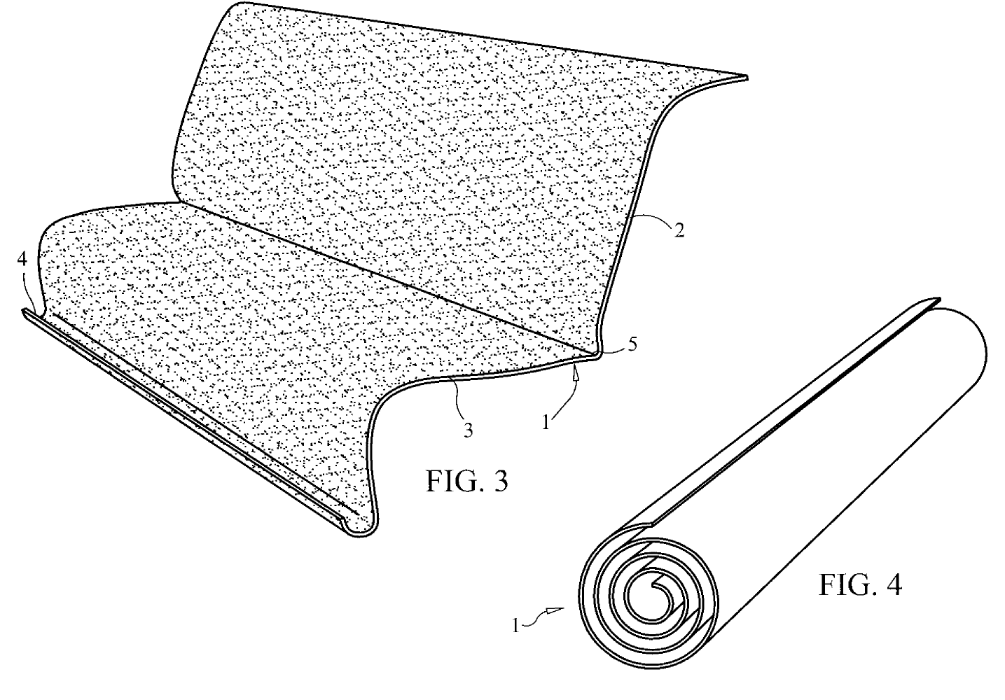

FIGS. 1A and 3 show a first embodiment of the mat 1 that rests on a top 106 of the seat back 102. In this embodiment, the mat 1 is draped over the top 106 of the backrest 102. The back portion lies on the top 106 and reaches the rear 107 of the backrest. By being draped over the backrest 102, the back portion 2 is held on the backrest 102 and therefore the entire mat 1 is held on the seat 101.

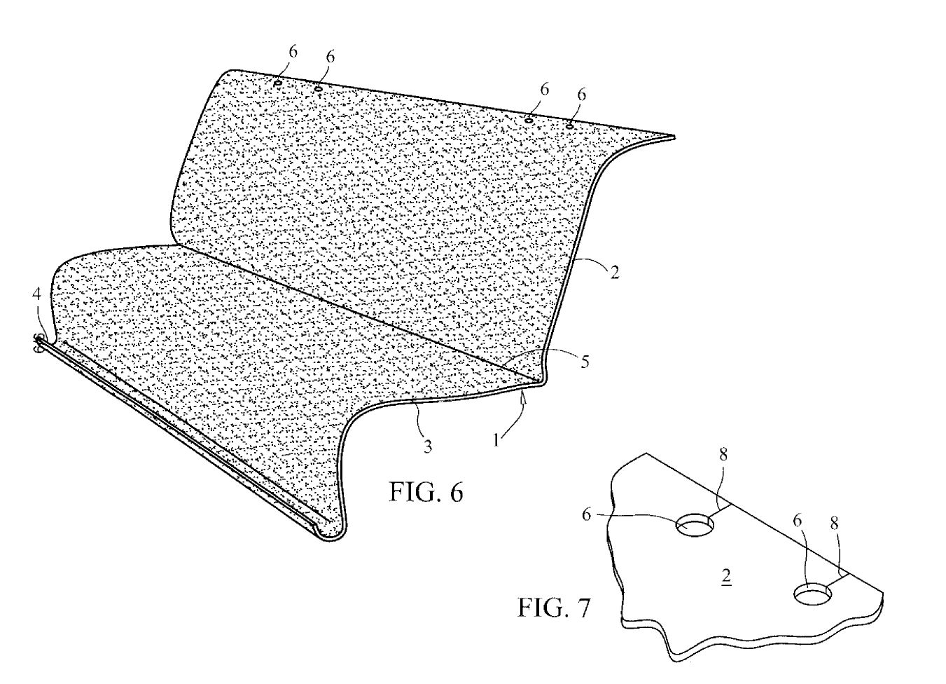

FIGS. 1E and 6 show a second embodiment of the mat 1 that is held on the seat 101 by a headrest 104. The back portion 2 has four holes 6 made in it, if the seat 101 has a middle headrest, which is not shown, the back portion 2 can include six holes 6. The headrest 104 has headrest posts 105 that insert in the backrest 102. To install the headrest 104, the headrest 104 is removed from the backrest 102. The headrest 104 is then reinserted by threading the headrest posts 105 through a hole 6. The mat 1 is thereby held on the seat 101.

FIG. 7 shows an embodiment of the back portion 2 also having holes 6 for receiving headrest posts 105 of the headrest 104. Slits 8 run from the holes 6 to the edge of the back portion 2. The slits 8 allow for easy and quick insertion of the headrest 104 into the holes 6 without needing to remove the headrest 104 from the backrest 102. Once inserted, the headrest posts 105 are held in the holes because the resilient nature of the mat 1 tends to close the slits 8.

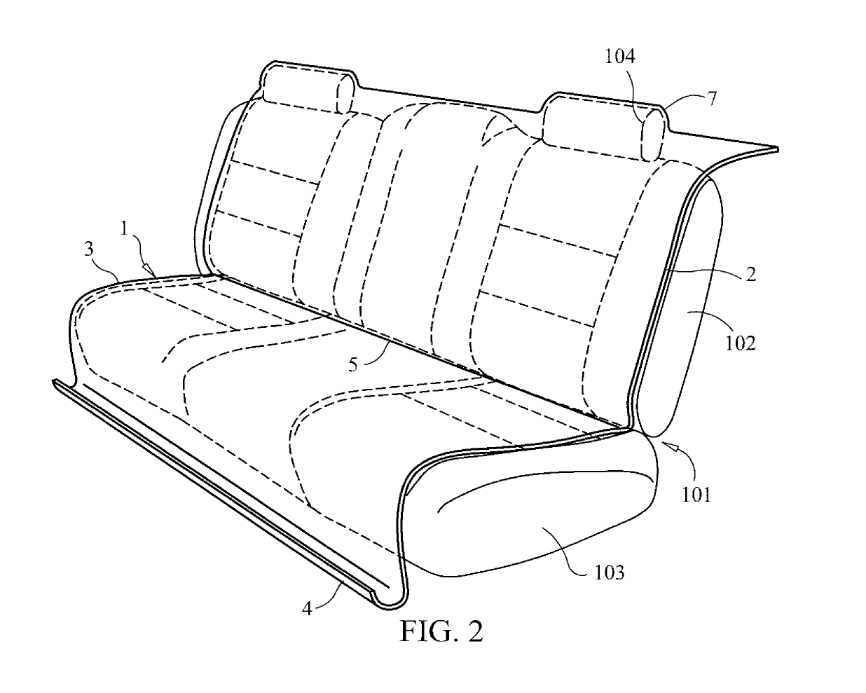

FIGS. 1C and 2 show a third embodiment of the mat 1. In this embodiment, a hood 7 is connected to the top of the back portion 2. The hood 7 fits over the headrest 104. Preferably, the hood 7 holds the headrest 104. The hood 7 holds the mat 1 on the seat 101 and can be easily removed from the headrest 104.

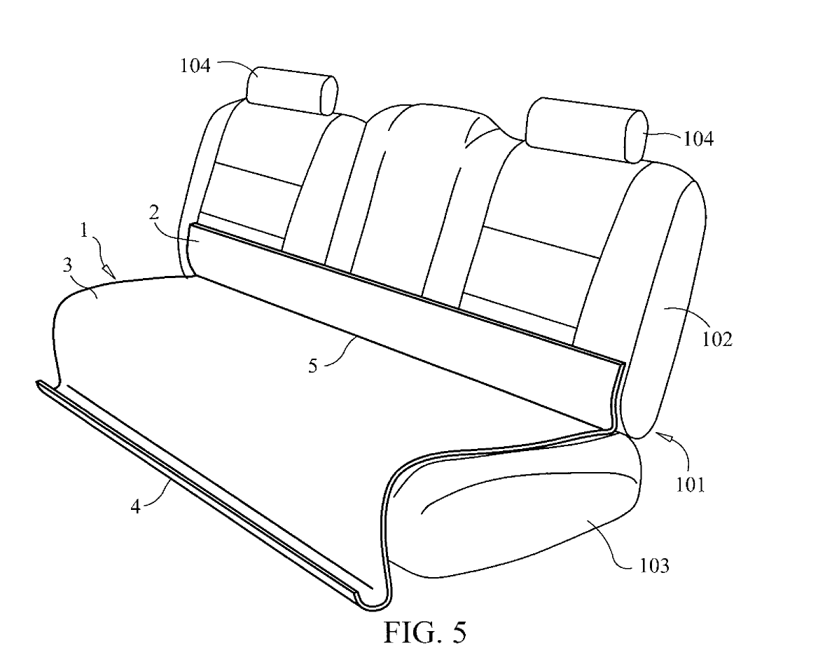

FIG. 5 shows an embodiment with a back portion 2 that covers only a portion of the backrest 2. Even though the backrest 2 is only partially covered, the frictional qualities of the PVC on the leather leg rest 103 are enough to hold the mat 1 on the seat 101.

The mat 1 includes a cuff 4 along the forward edge of the leg rest 103. The cuff 4 catches debris from the pet such as fur, dirt, and the like.

When not in use, the mat 1 can be rolled into a coil. The coil can be easily stowed in a vehicle's trunk for subsequent deployment. The coiled mat 1 is shown in FIG. 4.

I claim:

1. A mat for protecting a seat, comprising a leg portion made of flexible, closed-cell, expanded thermoplastic foam configured to cover a leg rest of the seat.

2. The mat according to claim 1, further comprising a back portion made of flexible, closed-cell, expanded thermoplastic foam connected to said leg portion and configured to cover a backrest of the seat.

3. The mat according to claim 2, wherein said back portion is configured to cover at least a portion of a top of the seat.

4. The mat according to claim 3, wherein said back portion is configured to cover a portion of a rear of the seat.

5. The mat according to claim 3, wherein said back portion has a hole formed therein configured for receiving a headrest post.

6. The mat according to claim 5, wherein said back portion has a slit formed therein from said hole to an edge of said back portion.

7. The mat according to claim 2, further comprising a hood connected to said back portion and configured for holding a headrest.

8. The mat according to claim 1, further comprising a cuff for catching dirt connected to said leg portion.

9. The mat according to claim 2, a crease formed where said leg portion joins said back portion.

10. The mat according to claim 1, wherein said flexible, closed-cell, expanded thermoplastic foam contacts said leg portion directly.

11. The mat according to claim 1, wherein said flexible, closed-cell, expanded thermoplastic foam is at least one centimeter thick.

12. The mat according to claim 1, wherein said flexible, closed-cell, expanded thermoplastic foam is polyvinyl-chloride.

13. The mat according to claim 1, wherein said flexible, closed-cell, expanded thermoplastic foam is neoprene.
